(19) United States
(12) Patent Application Publication
(10) Pub. No.: US 2015/0309847 A1
(43) Pub. Date: Oct. 29, 2015

(54) TESTING OPERATION OF MULTI-THREADED PROCESSOR HAVING SHARED RESOURCES

(71) Applicants: Puneet Aggarwal, New Delhi (IN); Vikas Chouhan, Keonjhar (IN); Eswaran Subramaniam, Bangalore (IN)

(72) Inventors: Puneet Aggarwal, New Delhi (IN); Vikas Chouhan, Keonjhar (IN); Eswaran Subramaniam, Bangalore (IN)

(73) Assignee: Freescale Semiconductor, Inc., AUSTIN, TX (US)

(21) Appl. No.: 14/262,793

(22) Filed: Apr. 27, 2014

(51) Int. Cl. G06F 9/52; G06F 9/30

(52) U.S. Cl. CPC G06F 9/524; G06F 9/30145

(57) ABSTRACT

A method of testing simultaneous multi-threaded operation of a shared execution resource in a processor includes running test patterns including irritator threads and non-irritator threads that try to simultaneously use the shared execution resource. Synchronizing the starts of the access of the irritator threads and the non-irritator threads to the shared execution resource includes the initial instructions of the irritator thread disabling execution of the irritator thread using a thread management register, and the initial instructions of the non-irritator thread enabling the irritator thread using the thread management register and starting execution of the non-irritator thread. Ending access to the shared execution resource includes the irritator thread communicating to the non-irritator thread an address of an end of the irritator thread loop, and the non-irritator thread moving the irritator thread out of the loop using thread restart.

### BACKGROUND OF THE INVENTION

The present invention is directed to testing processor operations and, more particularly, to testing simultaneous multi-threaded (SMT) operation of shared execution resources in a processor.

Integrated circuits (ICs) often include a processor that functions using multi-threading, where different threads can access shared execution resources simultaneously. A thread is a small sequence of instructions that are executed using hardware. When different threads try to use a shared execution resource at the same time, the processor must resolve any conflicts in the accesses of the threads so that they execute correctly.

The complexity of the interaction between the different threads and the shared resources requires verification by stress testing the processor hardware for multi-threading operation. Automatic test equipment (ATE) including a test pattern generator can apply test patterns of instructions to processors in order to identify causes of lack of data integrity. However, defective operations (bugs) are sufficiently few and far between for test run times to be long before certain bugs occur. Tests that stress shared resources, including shared execution units, produce frequent transactions in order for the bugs to appear with shorter test runs. However, preparing and synchronizing contending instruction streams for the test threads involves overhead routines that themselves may significantly lengthen the test times. Accordingly, it would be beneficial to have a method of testing multi-threaded operations of a processor.

### BRIEF DESCRIPTION OF THE DRAWINGS

The present invention, together with objects and advantages thereof, may best be understood by reference to the following description of embodiments thereof shown in the accompanying drawings. Elements in the drawings are illustrated for simplicity and clarity and have not necessarily been drawn to scale.

FIG. 1 is a schematic block diagram of conventional automatic test equipment connected to a processor to test the processor;

FIG. 2 is a flow chart of a method of testing simultaneous multi-thread functioning of a shared execution resource in a processor in accordance with an embodiment of the invention; and

FIG. 3 is a schematic block diagram of modules in automatic test equipment in accordance with an embodiment of the invention, given by way of example.

### DETAILED DESCRIPTION

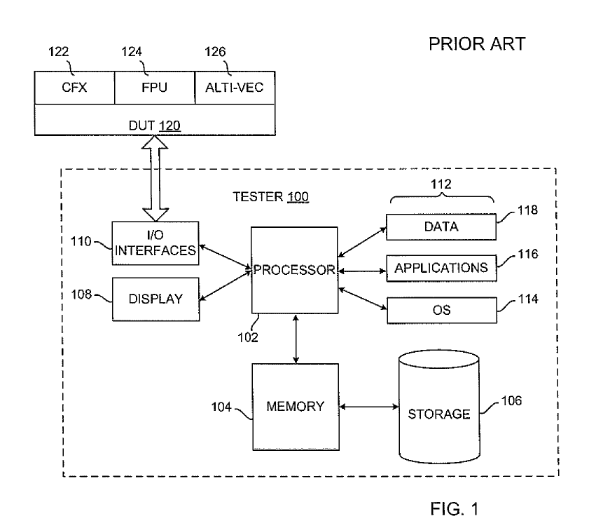

FIG. 1 illustrates a conventional automatic test equipment (ATE) 100 connected to test simultaneous multi-threaded (SMT) functioning of shared execution resources in a device under test (DUT) 120. The ATE 100 includes a processor 102 coupled to a memory 104 and additional memory or storage 106 coupled to the memory 104. The ATE 100 also includes a display device 108, input/output interfaces 110, and software 112. The software 112 includes operating system software 114, applications programs 116, and data 118. The applications programs 116 can include, among other elements, an automatic test pattern generator (ATPG) for running test patterns that apply instructions to the DUT 120 to test SMT functioning of shared execution resources of the DUT 120. The instructions include irritator operations that constitute transaction-based stimuli of an instruction stream applied to the DUT 120 and that are likely to cause conflict with instructions of non-irritator streams when trying to simultaneously access shared resources of the DUT 120. The ATE 100 compares results of the test patterns with expected results from the DUT 120 to detect, analyze and diagnose any bugs.

The ATE 100 generally may be conventional except for the software used to test the operation or functioning of the shared execution resources. When software or a program is executing on the processor 102, the processor 102 becomes a “means-for” performing the steps or instructions of the software or application code running on the processor 102. That is, for different instructions and different data associated with the instructions, the internal circuitry of the processor 102 takes on different states due to different register values, and so on, as is known by those skilled in the art. Thus, any means-for structures described herein relate to the processor 102 as it performs the steps of the methods disclosed herein.

The DUT 120 may comprise a processor or multi-processor system that has various shared resources, including shared execution resources. Examples of the shared execution resources include an integer unit (CFX) 122, a floating point unit (FPU) 124 and a media vector unit (AltiVec) 126. The DUT 120 is capable of SMT operation and may have a single processor core or a multi-processor system having two or more processing cores that function at the same time.

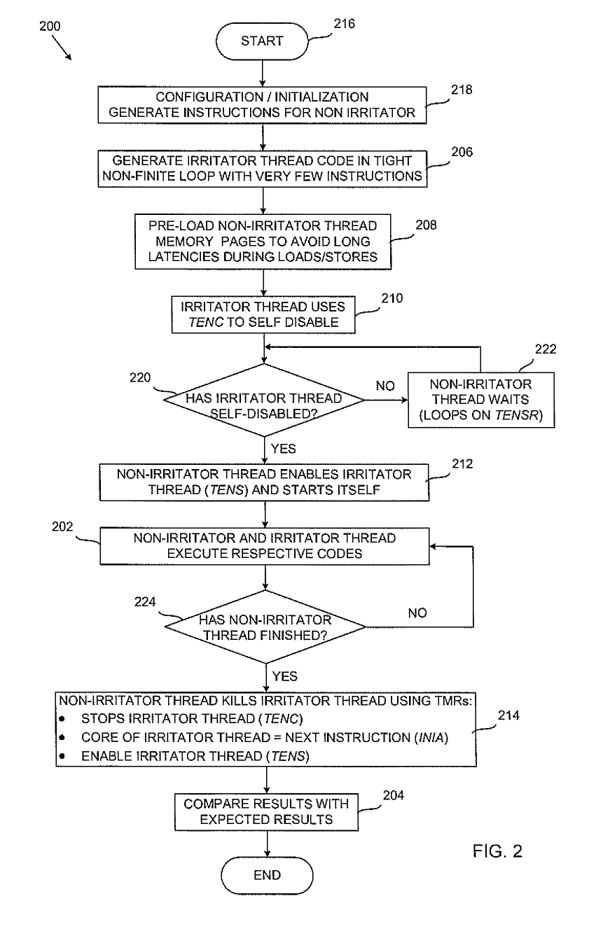

FIG. 2 is a flow chart illustrating an example of a method 200 of testing simultaneous multi-threaded (SMT) functioning of a shared execution resource, like the shared execution resources 122, 124, 126 in a processor (i.e., device under test (DUT) 120), in accordance with an embodiment of the invention. The method 200 may comprise instructions stored on a non-transitory computer-readable storage medium that, when executed by a test equipment such as the ATE 100, cause the test equipment to perform the method 200.

The method 200 comprises a step of running test patterns 202 including irritator threads and non-irritator threads trying simultaneously to access the shared execution resource 122, 124, 126, and a step 204 of comparing results of the test patterns with expected results. Running the test patterns 202 includes steps 206 and 208 of providing instructions for the irritator threads and the non-irritator threads. These steps will be discussed in more detail below. Synchronizing the starts of the access of the irritator threads and the non-irritator threads to the shared execution resource 122, 124, 126, includes at step 210 the initial instructions of the irritator thread disabling execution of the irritator thread using a thread management register, and at step 212 the initial instructions of the non-irritator thread enabling the irritator thread using the thread management register and starting execution of the non-irritator thread.

The method 200 enables precise synchronization of the irritator and non-irritator threads to be achieved, ensuring the threads try to access shared execution units 122, 124, 126 simultaneously. The synchronization bypasses a lot of overhead routines that would lengthen the test times by using hardware thread management features. For example, a conventional approach using shared translation look-aside buffer (TLB) and cache data paths during thread synchronization would lead to various performance disadvantages. With the method 200, the length of test time and number of test cycles to identify (hit) relevant bugs can be reduced. Instruction selection can be based on high latency instructions for irritator threads, and instruction selection granularity can be controlled for specific requirements.

The instructions of the irritator thread may run in a loop. The test patterns of the non-irritator thread may include many more instructions than the irritator thread. Ending access to the shared execution resource may include at step 214 the irritator thread communicating to the non-irritator thread an address of an end of the irritator thread loop at compile time, and the non-irritator thread moving the irritator thread out of the loop using thread restart. Ending access to the shared execution resource 122, 124, 126 may include the non-irritator thread stopping the irritator thread using the thread management register. The steps of disabling the irritator thread 210, enabling the irritator thread 212, and moving the irritator thread out of the loop 214 may include writing data respectively in a thread enable clear register (TENC), in a thread enable set register (TENS), and in a next instruction register (NIA).

The following description gives examples of pseudo-code that can be used to perform the operations described. However, it should be appreciated that other codes and other coding systems may be used. The method 200 starts at 216. A step 218 is performed for configuration and initialization of the test patterns and generation of instructions for the non-irritator thread that typically involves long routines. One of two threads T1, T2 is selected at random as an irritator thread and the other as a non-irritator thread.

```
execute(exec_unit = null)
{
  var threadList = {T1, T2}
  var instrList = { {intInstr}, {fpInstr}, {vecInstr} } //generic instructions
specific to execution unit
```

| | |
|---|---|
| var irrInstrList = {...} | //contains set of irritator |
| | instructions |

var execUnitList = { Int, FP, Vec } //contains processing units available
//thread selection
var irrThread = random(T1,T2)
var nonIrrThread = threadList − irrThread

The code generation for each thread is flexible to generate instructions for the targeted execution unit, within its processor core, for example the integer unit (CFX) 122, the floating point unit (FPU) 124, or the media vector unit (AltiVec) 126. The irritator thread, which involves very few instructions in a non-finite loop without loads or stores, is generated relatively quickly at step 206. At step 208, the non-irritator thread memory pages are pre-loaded, to avoid long latencies during loads and stores.

//code generation
var target = random(execUnitList) //target selection
var nonIrrCode = targetSpecificCode( target, instrList ) // repeat N
times: N is very large, > 1000 for example
var IrrCode = targetSpecificCode( target, irrInstrList ) // Runtime Infinite
Loop (repeat n times (random(irrInstrList[target] ))); // n is between 1 and
5 for example.

The first instruction of the irritator thread at step 210 sets the thread enable clear (TENC) register of its processor core to self-disable the irritator thread.

//thread synchronization
If ( thread = irrThread ){
TENC[irrThread] = 1; //self disable the irritator thread
}

Until the irritator thread is disabled, as indicated by its thread enable status register (TENSR), the non-irritator thread branches at 220 and waits at 222, looping on TENSR. When TENSR indicates that the irritator thread is disabled, at 212 the non-irritator thread writes in the thread enable set register (TENS) to enable the irritator thread, and starts its own code once TENSR of the irritator thread indicates that the irritator thread is enabled.

```
If ( thread = nonIrrThread ){
      while ( ! TENSR[irrThread] ) { /* loop until disabled */ }
      TENS[irrThread] = 1
      while ( TENSR[irrThread] ) { /* loop until enabled*/ }
}
```

At 202, both the irritator thread (in a tight loop) and the non-irritator thread (linearly) execute their respective codes.

//execute thread
execThread (irrThread, irrCode)
execThread (nonIrrThread, nonIrrCode)

Execution at step 202 of the codes continues until at step 224 the non-irritator thread finishes its test pattern. Then, at step 214, the non-irritator thread stops the irritator thread, by setting TENC, setting the next instruction register NIA of the irritator thread to an instruction just after a branch (making the loop open) and setting the TENS register of the irritator thread to end the test.

```
//complete thread execution
If ( thread = nonIrrThread ){
      TENC[irrThread] = 1
      while (TENSR[irrThread] ) { /* loop until irrThread disabled*/ }
      irrThread[NIA] = irrThread[LIA] + 0x4; //set PC of irr_thread
next to branch instruction of irrCode − LIA − Last Instr Addr
      TENS[irrThread] = 1
      while (!TENSR[irrThread] ) { /* loop until irr_thread enabled */ }
      }
}//end of main function.
```

This synchronizes termination of the irritator thread with completion of the non-irritator thread, without using shared TLB and cache data paths.

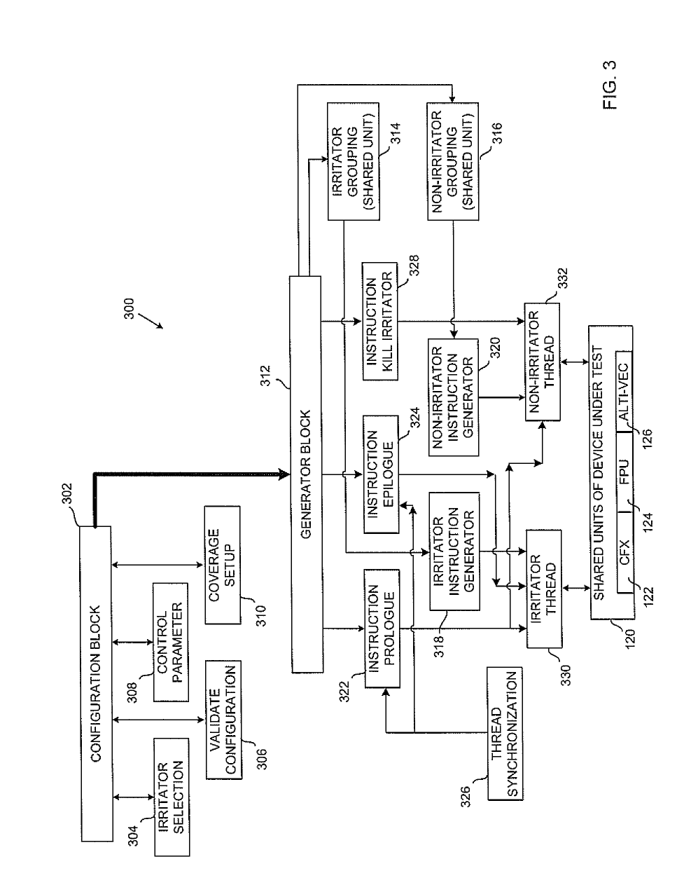

FIG. 3 illustrates the functional modules of a tester (ATE) 300 for testing SMT operation of a processor having a shared execution resource. The tester 300 runs test patterns including irritator threads and non-irritator threads that simultaneously access the shared execution resource. Apart from the functional modules, the tester 300 may be similar to the ATE 100.

The tester 300 comprises an instruction generator 312 to 316 that selects instructions from instruction lists for the irritator and non-irritator threads for the shared execution resource. The instruction generator 300 includes a synchronizer 322 to 328 for synchronizing the starts of the access of the irritator threads and the non-irritator threads to the shared execution resource. The synchronizer 322 to 328 provides initial instructions in the irritator thread disabling execution of the irritator thread using a thread management register, and provides initial instructions in the non-irritator thread enabling the irritator thread using the thread management register and starting execution of the non-irritator thread.

The instruction generator 312 to 316 may include a configuration validation module 306 that validates the configuration of instructions for the irritator and non-irritator threads, a control parameter module 308 that defines control parameters for the irritator and non-irritator threads, and a coverage setup module 310 that defines a coverage setup.

The ATE 300 has a configuration block 302 coupled to a irritator selection module 304 that selects the irritator thread, a configuration validation module 306 that validates the configuration, a control parameter module 308 that defines control parameters, and a coverage setup module 310 that defines the coverage setup.

The configuration block 302 activates a generator block 312 that pilots the thread generation. The generator block 312 controls modules 314 and 316 (cumulatively called instruction generator 312-316) that are units holding instruction lists for the irritator and non-irritator threads for the shared execution unit selected by the generator block 312. The instruction generator 312-316 also may include a prologue module 322 that provides the initial instructions in the irritator thread and the non-irritator thread, an epilogue module 324 that adds an epilogue to the irritator thread defining a move of the irritator thread out of a loop, and an irritator kill module 328 adding an instruction to the non-irritator thread stopping the irritator thread using the epilogue, the thread management register and thread restart.

Irritator and non-irritator generators 318 and 320, respectively, pick from the lists in the modules 314 and 316 to provide the instructions for the irritator and non-irritator threads.

The generator block 312 also controls the instruction prologue and epilogue modules 322 and 324. The thread synchronization module 326 activates the instruction prologue and epilogue modules 322 and 324 to add prologues to the irritator thread and non-irritator thread and to add an epilogue to the irritator thread. The module 328 adds an instruction to kill the irritator thread to the non-irritator thread. The resulting irritator thread and non-irritator thread are shown at 330 and 332 and provided to the DUT 120.

The invention may be implemented at least partially in a non-transitory machine-readable medium containing a computer program for running on a computer system, the program at least including code portions for performing steps of a method according to the invention when run on a programmable apparatus, such as a computer system or enabling a programmable apparatus to perform functions of a device or system according to the invention.

The computer program may be stored internally on computer readable storage medium or transmitted to the computer system via a computer readable transmission medium. All or some of the computer program may be provided on non-transitory computer-readable media permanently, removably or remotely coupled to an information processing system. The computer-readable media may include, for example and without limitation, any number of the following: magnetic storage media including disk and tape storage media; optical storage media such as compact disk media (for example CD ROM, CD R) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM and so on; and data transmission media including computer networks, point-to-point telecommunication equipment, and carrier wave transmission media, just to name a few.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In the claims, the word ‘comprising’ or ‘having’ does not exclude the presence of other elements or steps then those listed in a claim. Furthermore, the terms “a” or “an” as used herein are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of testing simultaneous multi-threaded (SMT) functioning of a shared execution resource in a processor, the method comprising:
running test patterns including irritator threads and non-irritator threads that simultaneously access the shared execution resource;
comparing results of the test patterns with expected results;
providing instructions for the irritator threads and the non-irritator threads; and
synchronizing the starts of the access of the irritator threads and the non-irritator threads to the shared execution resource, including the initial instructions of the irritator thread disabling execution of the irritator thread using a thread management register, and the initial instructions of the non-irritator thread enabling the irritator thread using the thread management register and starting execution of the non-irritator thread.

2. The method of claim 1, wherein the instructions of the irritator thread run in a loop.

3. The method of claim 2, wherein the test patterns of the non-irritator thread include more instructions than the irritator thread.

4. The method of claim 2, wherein ending access to the shared execution resource includes the irritator thread communicating to the non-irritator thread an address of an end of the irritator thread loop at compile time, and the non-irritator thread moving the irritator thread out of the loop using thread restart.

5. The method of claim 4, wherein ending access to the shared execution resource includes the non-irritator thread stopping the irritator thread using the thread management register.

6. The method of claim 4, wherein the steps of disabling the irritator thread, enabling the irritator thread, and moving the irritator thread out of the loop include writing data respectively in a thread enable clear register, in a thread enable set register, and in a next instruction register.

7. A tester for testing simultaneous multi-threaded (SMT) operation of a process having a shared execution resource, wherein the tester runs test patterns including irritator threads and non-irritator threads that simultaneously access the shared execution resource, the tester comprising:
a comparison module that compares results of the test patterns with expected results; and
an instruction generator that selects instructions from instruction lists for the irritator and non-irritator threads for the shared execution resource, wherein the instruction generator includes:
a synchronizer synchronizing the starts of the access of the irritator threads and the non-irritator threads to the shared execution resource, the synchronizer providing initial instructions in the irritator thread disabling execution of the irritator thread using a thread management register, and providing initial instructions in the non-irritator thread enabling the irritator thread using the thread management register and starting execution of the non-irritator thread.

8. The tester of claim 7, wherein the instruction generator includes:
a configuration validation module that validates the configuration of instructions for the irritator and non-irritator threads;
a control parameter module that defines control parameters for the irritator and non-irritator threads; and
a coverage setup module that defines a coverage setup.

9. The tester of claim 7, wherein the instruction generator includes:
a prologue module that provides the initial instructions in the irritator thread and the non-irritator thread;
an epilogue module that adds an epilogue to the irritator thread defining a move of the irritator thread out of a loop; and
an irritator kill module that adds an instruction to the non-irritator thread to stop the irritator thread using the epilogue, the thread management register and thread restart.

10. A non-transitory computer-readable storage medium storing instructions that, when executed by an automatic test equipment (ATE), cause the ATE to test simultaneous multi-threaded (SMT) functioning of a shared execution resource in a processor, the method comprising running test patterns including irritator threads and non-irritator threads that simultaneously access the shared execution resource, and comparing results of the test patterns with expected results, the test patterns including:
loading instructions for the irritator threads and the non-irritator threads; and
synchronizing the starts of the access of the irritator threads and the non-irritator threads to the shared execution resource, including the initial instructions of the irritator thread disabling execution of the irritator thread using a thread management register, and the initial instructions of the non-irritator thread enabling the irritator thread using the thread management register and starting execution of the non-irritator thread.

11. The non-transitory computer-readable storage medium of claim 10, wherein the instructions of the irritator thread run in a loop.

12. The non-transitory computer-readable storage medium of claim 11, wherein the test patterns of the non-irritator thread include more instructions than the irritator thread.

13. The non-transitory computer-readable storage medium of claim 11, wherein ending access to the shared execution resource includes the irritator thread communicating to the non-irritator thread an address of an end of the irritator thread loop at compile time, and the non-irritator thread moving the irritator thread out of the loop using thread restart.

14. The non-transitory computer-readable storage medium of claim 13, wherein ending access to the shared execution resource includes the non-irritator thread stopping the irritator thread using the thread management register.

15. The non-transitory computer-readable storage medium of claim 13, wherein the steps of disabling the irritator thread, enabling the irritator thread, and moving the irritator thread out of the loop include writing data respectively in a thread enable clear register, in a thread enable set register, and in a next instruction register.
